(19) United States
(12) Patent Application Publication
(10) Pub. No.: US 2012/0169297 A1
(43) Pub. Date: Jul. 5, 2012

(54) SECONDARY BATTERY WITH A RAPID CHARGING CAPABILITY

(75) Inventors: Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/382,399

(22) PCT Filed: Jun. 22, 2010
(86) PCT No.: PCT/EP10/03810

§ 371 Date: Mar. 20, 2012

(30) Foreign Application Priority Data
Jul. 7, 2009 (DE) 10 2009 032 050.4

(51) Int. Cl. H02J 7/00

(52) U.S. Cl. 320/150

(57) ABSTRACT

The invention relates to a secondary battery, in particular a lithium-ion secondary battery, which has a rapid charging capability. The secondary battery has at least one electrochemical cell and an electrical charge control system, wherein the electrochemical cell has at least two electrodes and at least one separator, wherein the charge control system is designed to monitor the process of charging the secondary battery such that, at least at times, it allows a relative charging current with a charging current value which, in particular, is at least 1 C, and wherein the separator has a coating which is composed of an ion-conducting material which has at least one inorganic component. The invention furthermore relates, in particular, to a lithium-ion secondary battery, to a charge control system for a secondary battery, to an electrochemical cell for a secondary battery, to an arrangement comprising at least one electrode and a separator for an electrochemical cell such as this, and to a method for carrying out a rapid charging process of a secondary battery.

The present invention relates to a secondary battery, in particular a lithium-ion secondary battery, a charging control system for a secondary battery, a galvanic cell for a secondary battery, an arrangement formed of at least one electrode and a separator for such a galvanic cell, and a method for carrying out a rapid charging process of a secondary battery.

An important aspect in the provision of secondary batteries is the charging period, or charging time, within which the secondary battery can be recharged again from a discharged condition. It plays an important part in particular in the operation of high-energy and high-power secondary batteries, in particular of the lithium-ion accumulator type, as drive batteries in motorised vehicles. Such secondary batteries, due to their high energy storage requirements, have correspondingly high capacities. When charging, on account of the large capacity of the secondary batteries, the problem occurs that in order to obtain an acceptable charging time, in particular as short a charging time as possible, the charging current must be relatively large. A large charging current, in particular due to the finite internal resistance and the electrical resistances of the current-carrying conductors of every secondary battery, leads to a thermal loading on the secondary battery, in particular on its cells, which represents a safety risk. Most commercially available secondary batteries, particularly lithium-ion secondary batteries, can therefore for safety reasons be charged with a low charge current with an upper limit, which can lead to a charging time of as long as e.g. more than eight hours.

The object of the present invention is to provide a secondary battery, in particular a lithium-ion secondary battery, a charging control system for a secondary battery, a galvanic cell for a secondary battery, an arrangement formed of at least one electrode and a separator for such a galvanic cell, and a method for carrying out a rapid charging process of a secondary battery, which can facilitate a rapid charging process and at the same time are safe.

The present invention achieves this object by the subject matter of the independent claims, in particular with the secondary battery according to claim 1, with the charging control system for a secondary battery according to claim 12, with the galvanic cell for a secondary battery according to claim 13, with the arrangement formed of at least one electrode and a separator for such a galvanic cell according to claim 14, and with the method for carrying out a rapid charging process of a secondary battery according to claim 15. Preferred configurations of the invention are the subject matter of the dependent claims.

The secondary battery according to the invention is in particular a lithium-ion secondary battery, but can also be another type of secondary battery apart from a Li-ion secondary battery, and has a rapid charging capability. The secondary battery comprises at least one galvanic cell and an electric charging control system, wherein the galvanic cell has at least two electrodes and at least one separator, wherein the charging control system is designed to control the charging process of the secondary battery in such a manner that it provides, at least at times, a relative charging current with a charging current value, wherein the relative charging current is the charging current expressed in relation to the capacity of the secondary battery with the unit C (A/Ah), and wherein this charging current value is at least 1C and the separator has a coating comprising an ion-conducting material which has at least one inorganic component, wherein the coating is designed such that it is stable when the charging current is present.

In the present description definitions are given and preferred configurations of the secondary battery are described, in particular of a lithium-ion secondary battery, of the charging control system for a secondary battery, a galvanic cell for a secondary battery, an arrangement formed of at least one electrode and a separator for a galvanic cell, and a method for carrying out a rapid charging process of a secondary battery, according to the invention. In addition, general technical definitions in the field of battery technology can be found in the book “Handbook of Batteries”, David Linden, Thomas B. Reddy, Third Edition, 2002, MacGraw-Hill.

The secondary battery according to the invention, the charging control system, the galvanic cell and the arrangement formed of the electrode and separator for the galvanic cell are preferably designed in particular for use as a drive battery of a motorised vehicle or optimised for this application. A motorised vehicle in the sense of the present invention is to be understood as vehicles of all types which draw their kinetic energy of motion, at least in part, from an engine which extracts energy from an energy source (energy store) and converts it, at least in part, into kinetic energy of the vehicle. Typical examples of such motorised vehicles are, among others, powered vehicles for use on the road, e.g. two-wheeled (e.g. bicycles) or four-wheeled powered vehicles, locomotives, ships and aircraft. The types of engines used are in particular, but not exclusively, combustion engines, electric motors and combinations of such propulsion units, so-called hybrid drives.

The invention is not limited however to use in motorised vehicles, but can in particular be used everywhere where rapid charging batteries are useful, e.g. in mobile telephones and notebooks and other electronic entertainment devices or domestic appliances or tools, in particular for the home office or for professional use and the like.

A lithium-ion battery in the present context is to be understood to mean a lithium-ion rechargeable battery, a lithium-ion secondary battery, a lithium-ion-battery or a lithium-ion cell from which batteries or rechargeable battery devices are formed by the series connection of individual lithium-ion cells. That means that in this context the term lithium-ion battery is used as a collective term for the above-cited terms which are commonly used in the prior art.

By fast charging, or rapid charging, capability is to be understood in this context that the charging of the secondary battery from a discharged state of preferably 5% or preferably 20% into a charged state of preferably either 60%, preferably 85% or preferably 95% of its full capacity can be or is completed within a charging time, wherein this charging time in each case is preferably a maximum of 240 min, 180 min, 120 min, 90 min and more preferably a maximum of 60 min, 45 min, 30 min, 15 min, 5 min or 1 min. By “full capacity” here is meant the capacity which the secondary battery can maximally achieve based on its present usage state. This full capacity can therefore be e.g. less than or equal to the nominal capacity or original maximum capacity of the secondary battery.

The relative charging current with which the secondary battery is charged is usually defined as the charging current expressed in relation to the capacity of the secondary battery or battery cell, so that e.g. a secondary battery with a capacity of 10 Ah (Ampere-hours) charging with an absolute charging current of 10A has a relative charging current of 1C (unit C=A/Ah=1/h). The charging current value is preferably at least 1C, 2C, 4C, 6C, 8C, 10C, 12C, 15C, 20C, 40C, 80C or 100C. The choice of the charging current value depends in particular on the choice of the active material of the electrodes and in particular on the choice of the material of the separator.

The inventors have discovered that the use of a particular coating for the separator, in particular when using certain materials for the electrodes, enables a rapid-charging capable secondary battery to be provided and both a corresponding rapid-charging capable galvanic cell and a rapid-charging capable arrangement of an electrode and separator to be provided. The resulting rapid charging capability of the secondary battery is attributable to the special ion-conducting properties of the separator and in addition, to the fact that both the coating, the corresponding separator, the corresponding arrangement of electrode and separator, the corresponding galvanic cell and the battery itself have a higher thermal loading capacity, which means that higher charging currents can be tolerated and therefore shorter charging times can be obtained. This superiority is particularly noticeable relative to such known secondary batteries, the separators of which e.g. only have a polyethylene basis.

The coating comprises an ion-conducting material which has at least one inorganic component. The inorganic component of the separator preferably has a microporous layer for impregnation with an electrolyte, the pore sizes of which are in particular essentially smaller than 4, 2 or 1 μm. The coating or the inorganic component is, in addition, preferably ceramic or preferably comprises a ceramic component. The ceramic is preferably an oxide ceramic and can comprise aluminium oxide, magnesium oxide, zirconium oxide, titanium dioxide, either alone or in any desired combination. The coating particularly preferably comprises magnesium oxide. The inorganic component of the separator preferably corresponds to an inorganic component of the commercially available separator composite material with the trade name SEPARION, which is available from Evonik AG, based in Germany. This coating additionally preferably corresponds to the coating material SEPARION.

A separator composite material is to be understood as a material for separating or isolating the electrodes in an electrochemical device, in particular of a lithium-ion battery, as is known for example under the name Separion®, or as is described for example in WO 2004/021499 or WO 2004/021477 and in particular in EP 1 017 476 B1.

In the sense of the invention, the coating of the separator, or a separator, is to be understood as an electrically insulating device which separates and spaces apart an anode from a cathode. Preferably, a separator layer is applied to an anode layer and/or a cathode layer. Alternatively, the porous functional layer can also be applied directly on the electrode, e.g. on the active layer of a negative electrode. The separator layer, or the separator, also at least partially accommodates an electrolyte, wherein the electrolyte preferably contains lithium ions. The electrolyte is also electrochemically effectively connected to adjacent layers of the electrode stack. Preferably, the geometric shape of a separator essentially corresponds to the shape of an anode of the electrode stack.

A separator is preferably implemented with thin walls, e.g. 4-25 μm thick, particularly preferably as a microporous film. A separator is preferably implemented with a non-woven fabric made from electrically non-conducting fibres, wherein the non-woven fabric is coated with an inorganic material on at least one side. EP 1 017 476 B1 describes such a separator and a method for its production. Preferably, the separator layer or the separator is wetted with an additive, which also increases the mobility of the separator layer or the separator. Particularly preferably, the wetting is effected with an ionic additive. The separator layer or the separator preferably extends, at least in some regions, over a bounding edge of at least one electrode. Particularly preferably, the separator layer or the separator extends beyond all the bounding edges of adjacent electrodes.

Due to the use of the separator with this coating in accordance with the invention, the risk of thermal runaway during the rapid charging n the secondary battery can in particular be reduced, whereby the operation of the secondary battery with rapid charging capability becomes safer. Thermal runaway is the fast and uncontrolled release and decomposition of active material of the electrodes under strong pressure build-up and temperature release, which is very difficult to stop. If a local short circuit of the internal electrodes occurs, e.g. in a lithium-ion accumulator, e.g. because the separator separating them is contaminated by an intrusive foreign particle or because another type of local inhomogeneity of the separator is present, then the short-circuit current can heat up the local environment of the impurity to such an extent that the surrounding regions are also affected. The process expands and releases the energy stored in the accumulator all at once. This effect can jump over to the surrounding cells and a cascade effect occurs. The total energy plus the reaction energy of a rechargeable Li-battery can then be released.

The mechanism of the thermal runaway reaction can occur at temperatures of 180° C. and above, but can also set in at temperatures above 80-150° C. if the SEI (solid electrolyte interface) layer of the negative electrode is damaged and this reacts, e.g. in an exothermal reduction of the electrolytes, with lithiated intercalation graphite. In a first phase, in particular in a first temperature regime up to 80-150° C., no thermal runaway reaction typically occurs. In a second phase, in particular in a second temperature regime up to around 180° C. and above, an additional reaction of the electrolyte on the cathode surface can begin, so that a pressure build-up occurs inside the cell. In a third phase, in particular in a third temperature regime above 180° C. and 200° C., a breakdown of the active material of the cathode can occur with an exothermic reaction of high magnitude. The anode passivisation layers can be completely destroyed and free electrolyte can be exothermically broken down. Very high temperatures and thick smoke can be caused by the decomposition of the cathode material.

In a cell with the separator according to the invention this is not initiated in the conventional manner, because this cell always remains stable in the first phase and the second phase, and no thermal runaway is triggered. A short-term influence of temperature and start of a reaction in the cell, e.g. around the 200° C. mark or above, triggers a local thermal runaway which does not continue or spread however. The cell is only damaged in certain areas. Due to this stable behaviour and the staunching of the reaction by means of these layers in a secondary battery, in particular a secondary battery in a high-energy and high-power design, in particular for driving motorised vehicles, the negative effect cannot transfer in a cascading manner to adjacent cells. The destruction of the entire rechargeable battery can thus be prevented, which means its operation becomes safer.

The coating is implemented such that when the charging current, which in particular to achieve a rapid charging is as high as possible, is present it is stable; where “stable” means that under normal circumstances, when apart from the temperature no additional disturbances are present, no thermal runaway reaction occurs. In order to keep the coating stable it is preferably designed such that it represents as small an electrical resistance as possible to the (ion) current and that in particular the resulting internal resistance of the secondary battery is as small as possible. The coating is preferably configured such that—optionally in accordance with the electrolyte used—the ion conductivity is as large as possible, in particular the conductivity for lithium-ions. It is possible and preferred that the average size of the micropores of the coating is chosen such that the coating is stable in the presence of the charging current. To achieve this, the pore size is kept as large as possible, in particular between 1 and 5 μm or between 1 and 4 μm or between 2 and 4 μm or between 3 and 4 μm in diameter. In addition, the coating preferably comprises molecular components that form amorphous or crystalline arrangements which promote the (lithium) ion flow and in particular facilitate the (lithium) ion flow in three spatial directions, instead of only in two spatial directions.

The charging control system is preferably part of a battery management system (BMS) or is a BMS or is contained in a BMS. Battery management systems of this kind not only monitor the electrical operating parameters of a (lithium-ion) accumulator but also its temperature, by using commonly available temperature sensors, arranged on the (lithium-ion) accumulator. Typically, the temperature sensors are mounted on the outside of the housing of a (lithium-ion) accumulator so that, in particular, any excessive heating, or even a local over-heating, at the current-carrying elements of the accumulator arranged inside the housing cannot be detected directly, or only after a time delay.

Preferably in the case of the secondary battery at least one temperature sensor assigned to the charging control system is provided, or multiple temperature sensors are provided, by means of which a temperature of the galvanic cell or multiple temperatures are detected. In this manner the cell temperature can be measured, which makes the battery safer. In particular, the charging time can be shortened if the charging control system is configured such that the charging current is maximised according to the permitted limit of the cell temperature. This limiting temperature is preferably chosen in accordance with—and in particular optimised to—the material of the separator or its coating and is preferably between 60° C. and 180° C., preferably between 70° C. and 100° C., preferably between 80° C. and 150° C., preferably between 80° C. and 120° C. or preferably between 100° C. and 120° C. The limiting temperature can take into account a temperature safety interval relative to the purely material-related possible limiting temperatures, which by taking account of empirically expected or calculated probability data, further reduces the probability of a thermal runaway.

The charging control system is preferably is preferably designed to control the charging process by taking account of a cell temperature of the galvanic cell and of a pre-determined limiting temperature. To this end the charging control system can have electrical circuits, in particular programmable electrical circuits, by means of which in particular a program for rapidly charging the secondary battery can be executed. By means of such a program a method, in particular that of claim 15, for carrying out a rapid charging process of a secondary battery can be implemented by the charging control system

The charging control system is preferably designed such that it controls the charging process in accordance with the cell temperature and the limiting temperature and in particular, reduces the absolute charging current or almost (e.g. to below 5% if the initial value of a temporarily constant charging current) or completely interrupts it, if the cell temperature reaches the limiting temperature.

The charging control system is in addition preferably designed such that the charging takes place by the constant-current charging method (CC), by the pulsed charging method, by the constant-voltage charging method (CV), by the constant-current constant-voltage charging method (CCCV) or by a method which combines these methods.

The charging control system is in addition preferably configured for rapid charging, in particular designed for charging the secondary battery from a discharged state of 20% into a charged state of preferably 60% or 85% of its full capacity within a charging time, wherein this charging time in each case is preferably a maximum of 240 min, 180 min, 120 min, 90 min and more preferably a maximum of min, 45 min, 30 min, 15 min, 5 min or 1 min. The charging control system for a secondary battery is preferably designed for carrying out a rapid charging process according to the method according to claim 15.

The charging control system is in addition preferably configured such that the charging current value is preferably at least 2C, 4C, 6C, 8C, 10C, 12C, 15C, 20C, 40C, 80C or 100C, or between two of these values.

The problem of thermal loading in the rapid charging of a secondary battery varies in magnitude, being dependent in particular on the material of the active layer of the positive electrode. One electrode of the galvanic cell, in particular the positive electrode (which during discharge of the battery corresponds to the cathode) preferably has an active layer which preferably comprises a phosphate compound, in particular a lithium-iron phosphate. An active layer can in particular be constructed as described and implemented in EP 0 904 607 B1.

The negative electrode of a lithium-ion battery is understood to mean the electrode at which the positively charged lithium ions, which are delivered through the electrolytes by the counter electrode (the positive electrode or cathode), collect during the charging process, and from which the lithium ions migrate back into the counter electrode during discharge.

In addition it is possible and preferable that an active layer of an electrode of the galvanic cell, in particular of the positive electrode, comprises a metal oxide, in particular the metal oxides of the metals nickel and/or manganese and/or cobalt. The active layer preferably comprises NMC (lithiated nickel-manganese-cobalt oxide), in particular with a proportion by weight of 85-95% and in particular in a quantity ratio of 1 Li to ⅓ each of Ni, Mn and Co. It has been surprisingly established e.g. that in the case of the combination of an NMC-electrode with a separator, which has the described coating, e.g. SEPARION coating, a thermal runaway reaction during the rapid charging process only occurs in the temperature region of >180° C. and the combination remained stable in the temperature regions <180° C. This observation applies in particular to secondary battery (stacked) cells with capacities of preferably greater than 10 Ah, preferably greater than 20 Ah, preferably greater than 30 Ah, preferably greater than 40 Ah, and applies e.g. in particular to a large-format stacked cell with >40 Ah and nominal 3.6 V.

One active layer can be formed from active material particles with a grain size of e.g. 5-40 μm. The active layer of the negative electrode referred to is to be understood as the layer in which the electrochemical processes of the accretion of lithium ions during charging, or the re-release of lithium ions in the electrolytes during discharge, take place.

This active layer can consist for example of graphite, so-called “Hard Carbon” (an amorphous modification of carbon) or of nanocrystalline, amorphous silicon, wherein the lithium ions accumulate in the above-mentioned materials by means of so-called intercalation during charging. If the negative electrode consists of graphite, during charging lithium ions move between the graphite layers (nC) of the negative electrode and with the carbon form an intercalation compound (LinxnC).

The active layer can also consist of lithium titanate (Li4Ti5O12). Additional materials for forming the active layer include, for example: metallic lithium; tin-based alloys; metallic nitrides or phosphides which are able to incorporate lithium, such as CoN3, NiN3, CuN3 or FeP2; nitrides LixMyN2, where M is for example Mo, Mn or Fe and preferably x=0.01 to 1, more preferably 0.2 to 0.9, and y=1−x; nitrides Li3−xMxN, where M is a transition metal and preferably x=0.1 to 0.9, more preferably 0.2 to 0.8; and/or phosphides LixMyPz, where M is a metal such as Cu, Mn or Fe and preferably x=0.01 to 1, more preferably 0.2 to 0.9, y=1−x; and z is a whole number chosen to be large enough that the compound has no electrical charge. The active layer can also consist of any desired mixture of the above-mentioned materials.

The active material particles referred to above are to be understood to mean the, for example crystalline, particles of the material forming the active layer, between which the lithium ions accumulate during charging. For graphite as the negative electrode material, an active material particle can also be a graphite layer. In an electrode produced for use in a lithium-ion cell, to form the active layer the active material particles can also be bound together by means of a binding agent, or can be adherent to one another.

The active layer can substantially consist of mutually adherent active material particles and the outer surface of the active layer is substantially formed by the surfaces of the active material particles exposed to the outside of the active layer. The phrase “surface exposed to the outside of the active layer” is to be understood as the surface of the active material particles forming the active layer that is accessible for the accumulation of the lithium ions. This outer surface of the active layer can be coated at least partially with nanoparticles or differently shaped nanoparticles.

One electrode and/or the separator can have a carrier or a carrier structure or carrier layer.

The carrier layer can substantially consist of carrier fibres and the outer surface of the carrier layer is then substantially formed by the surface of the carrier fibres exposed to the outside of the carrier layer. The construction of the carrier layer of carrier fibres has the effect that the carrier layer is self-supporting.

At least the uppermost fibre layer of the carrier fibres forming the carrier layer can be coated with nanoparticles substantially on all sides. This embodiment is advantageous if a fibre layer coated with nanoparticles is applied to a substrate of fibre layers which are not treated with nanoparticles in order to form the carrier layer.

The carrier fibres forming the carrier layer can also be coated with nanoparticles substantially on all sides. This embodiment is advantageous if the coating of the fibres with nanoparticles, in particular for example for reasons of adhesion, is carried out before the processing of the carrier fibres to form the carrier layer.

The carrier layer can consist of woven or non-woven carrier fibres. By this means, both woven fabrics as well as non-woven fabrics are possible in the application.

The carrier fibres can be polymer fibres or steel wires, in particular stainless steel wires, suitable for forming a mesh. Polymer fibres and steel wires are easily available and cost-effective starting materials for constructing the carrier layer for the separator composite material. The carrier layer is preferably a stainless steel mesh or a non-woven polymer fabric. These raw materials are particularly cost-effective ones for the carrier layer and are available in a variety of forms.

The active layers of the electrodes and/or the separator or the carrier can each be wholly or partially coated with nanoparticles (e.g. aluminium oxide (Al2O3), zirconium oxide (Zro2) or silicon oxide (SiO2) or a mixture of these or NMC). Nanoparticles are in this context preferably particles with a dimension, e.g. a diameter or a thickness, of less than 500 nm. Alternatively or in addition to nanoparticles, nanorods, nanoplates or particles formed from such nano-subparticles with more complex geometries, e.g. tetrapods, can be used for the coating. With a coating with such particles the performance of the negative electrode (anode when discharging), as has been found experimentally, can be improved, in particular when the particles are arranged on the active layer in a comb-like manner. Also, the resistance against a thermal runaway reaction, and thereby the rapid charging capability, can be improved with a coating with such particles.

The galvanic cell according to the invention for a secondary battery having a rapid charging capability comprises at least two electrodes and at least one separator, which in particular substantially incurs no structural damage at temperatures up to 180° C.

In the sense of the invention, a galvanic cell is to be understood as a device which also serves to emit electrical energy and to convert chemical energy into electrical energy. To do so, the galvanic cell has at least two electrodes of different polarity, and the electrolyte. Depending on its construction, when it is charging the galvanic cell is also capable of absorbing electrical energy, converting it into chemical energy and storing it. The conversion of electrical into chemical energy is lossy and accompanied by irreversible chemical reactions. An electrical current flow into or out of a galvanic cell can produce electrical heating power. This electrical heating power can lead to a temperature increase of the galvanic cell. With rising temperature, irreversible chemical reactions increase. These irreversible chemical reactions can cause regions of a galvanic cell to be no longer available for the conversion and/or storage of energy. With an increasing number of charging processes, these regions increase in size. This means that the usable charging capacity of a galvanic cell, or the device, falls off. The galvanic cell can comprise an electrode stack or multiple galvanic cells can form an electrode stack.

In the sense of the invention an electrode stack is also understood to mean a device which, as an assembly of a galvanic cell, also serves to store chemical energy and to emit electrical energy. Before the emission of electrical energy, stored chemical energy is converted into electrical energy. During the charging the electrical energy supplied to the electrode stack or the galvanic cell is converted into chemical energy and stored. For this purpose, the electrode stack comprises multiple layers, at least one anode layer, a cathode layer and a separator layer. The layers are placed on top of one another, or stacked, wherein the separator layer is arranged at least partially between an anode layer and a cathode layer. Preferably, this sequence of the layers is repeated many times within the electrode stack. Some electrodes are preferably electrically connected to one another, in particular connected in parallel. Preferably, the layers are wound up to form an electrode coil. In the following, the term “electrode stack” is also used for electrode coil.

The arrangement according to the invention, which has rapid charging capability, comprises at least one electrode and one separator for a galvanic cell, wherein the separator comprises a coating, which in particular at temperatures up to 180° C. substantially incurs no structural damage, and which optionally is applied to an electrode.

The method according to the invention for carrying out a rapid charging process of a secondary battery, in particular of a secondary battery according to the invention, which comprises a galvanic cell with at least two electrodes and at least one separator which comprises a coating having an ion-conducting material with at least one inorganic component, wherein the coating is designed such that it is stable in the presence of the charging current, comprises the steps: —at least temporarily providing a relative charging current having a charging current value which is in particular at least 1C; —preferably: using a limiting temperature which is preferably selected according to the chosen material of the coating of a separator, measuring a cell temperature of the galvanic cell; —preferably: controlling the charging process according to the cell temperature and the limiting temperature and in particular, reducing the absolute charging current or interrupting the charging current if the cell temperature reaches the limiting temperature. Further preferred steps of the method can be straightforwardly derived by the person skilled in the art from the present description of the secondary battery and its components.

Further preferred configurations of the devices or the method according to the invention can be obtained from the following description of the exemplary embodiment.

A lithium-ion secondary battery according to the invention in the example comprises a large-format galvanic stack cell with >40 Ah and nominal 3.6 V voltage. It comprises an electrode stack. The galvanic cell comprises negative electrodes based on graphite, positive electrodes based on NMC (NMC: lithiated nickel-manganese-cobalt oxide) and electrolyte with alkyl carbonates, additives and Li-conducting salt.

Between each negative and a positive electrode a separator is arranged, which is provided with a coating e.g. made of the coating material Separion®. As particular advantages of the coating in the operation of the secondary battery, it is found that the cells are more thermally stable and a good wettability of the material by the electrolyte is provided.

The separator comprises a carrier comprising a stainless steel mesh or a non-woven polymer fabric, provided with a resistant ceramic in the form of a ceramic membrane as a separator in the thickness range 4-45 μm.

The active material of the negative electrode is coated in a comb-like manner with nanoparticles (aluminium and zirconium oxide).

The active material of the positive electrode comprises NMC.

The galvanic cell has conductors. The conductors are part of a conductor device. In the sense of the invention a conductor device is to be understood as a device which during discharge, moves electrons out of a galvanic cell towards an electrical consumer. Preferably, the at least one conductor device is assigned to one of the electrodes of the galvanic cell, in particular connected to this electrode in an electrically conducting manner. A conductor device also facilitates a current flow in the opposite direction. The at least one conductor device is also preferably connected to a galvanic cell in a thermally conducting manner. If a corresponding temperature gradient is present a conductor device in the sense of the invention also transports heat energy out of a galvanic cell. The conductor device preferably comprises a metal. Particularly preferably, the conductor device comprises copper or aluminium.

The galvanic cell has temperature sensors near to the electrode conductors. Near to the conductors the temperature of the galvanic [cell] can rise particularly steeply, since a high charging current there can produce high temperatures. In these regions the temperature monitoring is therefore particularly useful, in order to prevent a thermal runaway reaction in particular.

The secondary battery comprises a charging control system, which is part of a BMS. The BMS is connected to the temperature sensors and determines the temperatures near to the conductors of the galvanic cell, in particular during charging and/or discharging of the cell. By programming with control software code, the BMS is designed to keep the charging current at a level such that a limiting temperature of 150° C. at each of the temperature sensors is not exceeded. In addition, the BMS regulates the charging current in such a manner that the limiting temperature lies in a tolerance range of e.g. 130 to 150° C., so that the possible charging current is also exploited to achieve as short a charging time is possible. In order to charge the secondary battery which is discharged to 20% of its full capacity up to 60% of the full capacity, a constant current with a relative charging current of 1C is first used. To do this, the charging control system requires a charging time of 2 hours. By this method the rapid charging capability can be shown.

Furthermore, this electrode-separator arrangement has the effect that the thermal runaway, which in conventional arrangements can be initiated in all temperature regimes, can finally occur only in the temperature range >180° C. and in the present case does not occur, so that the operation of the secondary battery is safe. This result was surprising and demonstrates the efficacy and the improved safety behaviour of the electrode-separator arrangement, or the secondary battery, and of the method according to the present invention.

1.-16. (canceled)

17. A charging control system for a secondary battery, in particular a lithium-ion secondary battery, having at least one galvanic cell which comprises at least two electrodes and at least one separator, the separator comprising a coating that is stable below a limiting temperature,
wherein
a temperature sensor assigned to the charging control system is provided, which detects a temperature of the galvanic cell and that
the charging control system is arranged such that it reduces or almost completely cuts off the absolute charging current when the cell temperature reaches the limiting temperature.

18. The charging control system for a secondary battery according to claim 1, characterized in that this limiting temperature lies between 60° C. and 180° C.

19. The charging control system for a secondary battery according to claim 18, characterized in that this limiting temperature is selected according to the material chosen for the coating of the separator.

20. The charging control system for a secondary battery according to claim 19, wherein the charging control system is designed for charging the secondary battery from a discharged state of 20% into a charged state of 60% or 85% of its full capacity within a charging time, wherein this charging time in each case is a maximum of 240 min, 180 min, 120 min, or 90 min.

21. The charging control system for a secondary battery according to claim 20, wherein the charging current value is at least 2C, 4C, 6C, 8C, 10C, 12C, 15C, 20C, 40C, 80C or 100C.

22. A battery management system for a secondary battery, having a charging control system according to claim 17.

23. A secondary battery having a charging control system according to claim 17, wherein one electrode of the galvanic cell comprises an active layer which preferably comprises a phosphate compound, in particular a lithium-iron phosphate, or metal oxides, in particular the metal oxides of the metals nickel and/or manganese and/or cobalt.

24. The secondary battery having a charging control system according to claim 17, wherein the inorganic component of the separator comprises a microporous ceramic layer for impregnation with an electrolyte, the pore sizes of which layer are in particular substantially smaller than 4 μm, which in particular comprises magnesium oxide.

25. The secondary battery having a charging control system according to claim 17, wherein the inorganic component of the separator corresponds to an inorganic component of the material with the trade name SEPARION, or that in particular this coating corresponds to the coating material SEPARION.

26. A galvanic cell for a secondary battery according to claim 25, having at least two electrodes and at least one separator, which at temperatures up to 180° C. in particular, substantially incurs no structural damage.

27. A method for carrying out a rapid charging process of a secondary battery according to claim 25, which comprises at least one galvanic cell having at least two electrodes and at least one separator, wherein the separator has a coating which is stable below a limiting temperature, comprising the steps:
detection of a temperature of the galvanic cell and
reduction or approximate/complete interruption of the absolute charging current when the cell temperature reaches the limiting temperature.
